(19) United States
(12) Patent Application Publication
(10) Pub. No.: US 2009/0274097 A1
(43) Pub. Date: Nov. 5, 2009

(54) INFORMATION TRANSMISSION TO AN AIRCRAFT

(75) Inventors: Tilo Budinger, Hamburg (DE); Carsten Vogel, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS DEUTSCHLAND GMBH, Hamburg (DE)

(21) Appl. No.: 12/432,070

(22) Filed: Apr. 29, 2009

Related U.S. Application Data
(60) Provisional application No. 61/126,635, filed on May 5, 2008.

(30) Foreign Application Priority Data
May 5, 2008 (DE) 10 2008 022 130.9

(51) Int. Cl. H04W 40/00; H04W 4/14

(52) U.S. Cl. 370/328; 455/466

(57) ABSTRACT

A system and a method for information transmission to an aircraft and for the subsequent provision of the information, which includes an information system for an aircraft including a receiver for receiving a message in a mobile communication standard from a ground system. The message contains a message header and a message body including information prepared with a further header. An interpreter analyses the further header of the message and separates the information, and at least one display device is provided for presenting the information. The receiver is connected to the display device by way of the interpreter so as to be able to communicate. The messages transmitted are, for example, SMS messages or MMS messages.

### CROSS-REFERENCE TO RELATED APPLICATIONS

This application claims the benefit of the filing date of U.S. Provisional Patent Application No. 61/126,635 filed May 5, 2008, the disclosure of which is hereby incorporated herein by reference.

### FIELD OF THE INVENTION

The invention relates to a system and a method for information transmission to an aircraft and for the subsequent provision of the information. Particularly, the invention relates to an aircraft with such a system and the use of such a system in an aircraft.

### BACKGROUND TO THE INVENTION

There are different ways of supplying information to persons within an aircraft, in particular within an aeroplane. For aerotechnical and safety-relevant information there are, for example, radio connections between the aircraft, i.e. the cockpit, and the ground, e.g. flight control, tower etc. or above-ground communication devices such as satellites or other aircraft. More recently, special units that are situated on-board aircraft are known which units make it possible for passengers to communicate using their own mobile telephones. These special units are necessary because on-board operation of commercially available mobile telephones is otherwise not permitted for safety reasons, in order to prevent electromagnetic interference with the electronic on-board systems of the aircraft. These units provide a dedicated mobile communications cell in the cabin, thus ensuring that the mobile devices are scaled to low transmission output in order to ensure interference-free operation of other electronic systems.

### SUMMARY OF THE INVENTION

There may be a need to provide the persons on board the aircraft, in particular the passengers, with current information, in particular during extended periods spent on board, for example during long-haul flights. It is, for example, known to present current travel data on a display, in particular the current position as well as the remaining flight time and similar. However, this data is generated on board the aircraft and is subsequently graphically prepared and presented in a map or in an image that for these purposes is stored on board the aircraft. The display of any transfer options and connecting flights at the destination is usually also based on data which is deposited in a memory on board, or which has been entered via radio and subsequently by an announcement or manually by members of the flight crew.

In the context of the general increase in information supply it has, however, been shown that on board an aircraft, too, there is a substantial need to provide current information to the persons on board.

Thus, there may be a need to provide a method and a system by which current information can quickly and economically be provided on board.

According to an exemplary embodiment of the invention, an information system for an aircraft comprises a receiver for receiving a message in a mobile communication standard from a ground system, wherein the message contains a message header and a message body, said message body comprising information prepared with a further header; an interpreter that analyses the further header of the message body in the message and separates the information; and a display device for presenting the information, wherein the receiver is connected to the display device by way of the interpreter so as to be able to communicate.

The invention comprises an advantage in that the actual information transmitted in the message can be transmitted preferably in an existing standard with the use of an existing and often-used communication infrastructure. The further header according to an exemplary embodiment of the invention, which further header is contained in the message body together with the information, makes it possible, apart from transmitting the actual information, to transmit additional data, which is not possible in the case of a pure message. For example, the details in the further header make it possible to activate the interpreter that carries out or initiates the steps necessary for presentation. The information that is to be made available in the aircraft can be generated not only independently of the position of the aircraft, but also independently of the time. This means that the information, e.g. up-to-date news, can be generated at any desired location and can subsequently be transmitted economically. Generating or compiling the information can, for example, take place by the airline if the aircraft is a scheduled-service plane. The information can also be provided by special private or public providers. The information can, for example, be current stock exchange information or sports results which within the passenger cabin are presented as a so-called liveticker on a display device. The information can, of course, also be an urgent message or a news summary.

In an exemplary embodiment in which the information is in the form of text information, in which the message is an SMS message in the SMS (short message service) mobile communications standard, and in which the interpreter is a text interpreter. In this way the data quantity to be communicated can be reduced to the bare essentials. The SMS standard is a widely used standard that allows universal use. Since only text information is transmitted and further processed, the interpreter can be a text interpreter, which as a rule requires little computing power of the interpreter. Thus in this exemplary embodiment text-based information is transmitted.

In a further exemplary embodiment the information is image information, and the message is an MMS message in the MMS (multimedia messaging service) mobile communications standard. The system is thus able to provide image information, and at the same time to keep the data quantity to be communicated as small as possible, for example in order to ensure fast transmission times and low operating costs.

In a further exemplary embodiment the further header comprises an identification code which comprises security-related details and/or details relating to the type of information. The provision of security-related details ensures that only information intended for this purpose is further processed or presented, while incorrect or even criminal information, which may contain viruses or similar, can be detected in time as a result of the security-related details. By inserting details relating to the type of information, information groups or message groups can be introduced as required, which groups can be helpful in further processing. For example, very important messages can be marked as such, and consequently they are displayed immediately.

In a further exemplary embodiment the interpreter comprises an identification unit in which details relating to the verification of the security-related details of the further header, and an assignment of various types of information to at least one of various presentations and to one of various display devices, are deposited. Assignment to various display devices makes it possible, for example, to present in a targeted manner information that is only intended for the cockpit, i.e. for the pilots or the crew, on displays that are not accessible to passengers.

In a further exemplary embodiment the information provided is presented on the display device combined with other content. In this way the information can be presented in the on-board information- and entertainment program, which differs depending on the aircraft operator. Other content can, for example, be high-resolution images or videos that are stored on board the aircraft in a data storage device in order to serve as a background, depending on the information: the information is then shown in layers as a text or an image. In this arrangement the images or videos in the layer below can also present further information relating to the overlaid message. As a result of the storage of the other content on board the aircraft, the external data transfer for such a service for providing current information of the aircraft is limited to the actual message, in other words for example an SMS or MMS, of course except any aerotechnical communication.

In a further exemplary embodiment the receiver on board the aircraft comprises a GSM module that only comprises a receive function, for example a pure SMS- or MMS receive function. This technique involves economical and proven components. As a result of the reduction to a receive function only, simple and robust technology is provided, which furthermore is also weight-optimised and space-optimised, which is of central importance in aircraft. If a GSM module is already on board for other reasons, this GSM module can be utilised to the extent that only its receive function is used.

Further provided is an exemplary embodiment in which the interpreter comprises an interface with an input unit and is connected to a database and an internal memory on board the aircraft. In this way information can be stored and can be retrieved or made available again at a later point in time. Storing messages makes it possible, for example in the case of individual display devices, i.e. where a display is directly associated with a passenger, to present messages relating to particular topics only at the point in time when the display is activated; for example when the user has been asleep for some time and would thus otherwise have missed the message. Furthermore, it is also provided, for example, for stock exchange information to be displayed only when the user, i.e. the passenger, has, for example, the stock exchange channel of the onboard information system switched on. Furthermore, by the interface, in addition to the details contained in the further header, the information can be assigned to particular groups or displays. Moreover, the database can comprise the already-mentioned high-resolution images and videos. It is understood that it is, for example, also possible to present the information on all the displays and to store it at the same time, or to store it first and then show it on all the displays by manual or automatic call-off.

In a further exemplary embodiment an information system for an aircraft is provided, comprising: a receiver for receiving a message in a mobile communication standard from a ground system, wherein the message contains a message header and a message body, said message body comprising information prepared with a further header, said further header comprising display specifications; an interpreter that analyses the further header of the message body in the message and separates the information and the display specifications; and a display control unit on board the aircraft; at least one on-board display device for presenting the information, wherein the receiver is connected to the display device by way of the interpreter so as to be able to communicate; and wherein the display control unit controls the display device in accordance to the display specifications.

The present invention furthermore provides an aircraft with an information system according to one of the exemplary embodiments described above.

The use, according to an exemplary embodiment of the invention, of an information system according to one of the exemplary embodiments described above, in an aircraft, is associated with an advantage in that even during flight operation current information can in a simple and economical manner be provided within the aircraft.

Furthermore, according to an exemplary embodiment of the invention, a system for the transmission of information to an aircraft is proposed, which system comprises an information system for an aircraft according to one of the above exemplary embodiments, as well as a ground system for data processing, wherein the ground system provides an input device for inputting the information, and a data processing unit that adds the further header to the input and makes said prepared input available as the message body of the message in the mobile communication standard, as well as comprising a transmitter that transmits the prepared message. The ground system is essentially based on economical components so that, as a supplement to the information system described above, an economical and also reliable overall system for information transmission to an aircraft can be provided, which system is eminently suitable for operation by an aircraft operator, and into which system even aircraft from different countries can be integrated. For example, the ground system can also be operated by a subsidiary or a separate operator. Available services from third parties can be used for communication between the ground system and the information system of the aircraft, so that no additional measures are required. For example, the transmitter of the ground system can be connected to a telecommunication services provider by a terrestrial data transmission network. Said telecommunication services provider in turn also provides the data communication with the aircraft, for which purpose in particular situations, for example on ground in the parked position and possibly also on the taxistrip, in the taxi phase, terrestrial radio networks as used for mobile telephone devices are also suitable. In order to take into account security-relevant aspects an interface on board the aircraft can be provided, which automatically interrupts or switches off the radio connection if required; for example the receiving module can be automatically switched off during takeoff and landing procedures, during which the safety requirements relating to possible sources of interference are particularly stringent. Furthermore, it is also possible to switch the radio connection to the terrestrial radio network off if a particular flight altitude is exceeded, wherein the flight altitude can be provided by the on-board altimeter. For greater flight altitudes or in areas without network coverage, satellite systems are suitable for establishing a communication link with the receiver on board the aircraft. In particular, in the links just mentioned, the small quantity of data results in significant savings in operator costs when compared to large-volume data transport.

Furthermore, according to an exemplary embodiment of the invention, a method for the transmission of information to an aircraft is provided, which method comprises the steps of: generating information; preparing the information for a message body of a message in a mobile communication standard, which message comprises the message body and a message header by providing the information with a further header; converting the prepared text information into a message in a mobile communication standard, wherein the message comprises a message header and a message body comprising the information prepared with the further header; transmitting the message to an information system on board an aircraft; interpreting the message by analysing the further header of the message body and separating the information by an aircraft-internal information system; and presenting the information on board the aircraft.

According to a further exemplary embodiment, a method for the transmission of information to an aircraft is provided, which method comprises the steps of: generating information; preparing the information for a message body of a message in a mobile communication standard, which message comprises the message body and a message header by providing the information with a further header; converting the prepared text information into a message in a mobile communication standard, wherein the message comprises a message header and a message body comprising the information prepared with the further header, by providing the message body with the message header; transmitting the message to an information system on board an aircraft; interpreting the message by analysing the further header of the message body and separating the information by an aircraft-internal information system; and presenting the information on board the aircraft.

Among other things the method according to an exemplary embodiment of the invention is characterised in that at first information is generated, as far as possible in a known manner, for example by inputting text on a normal personal computer with the use of a keyboard. In the case of intended text information the information can also be generated by voice input and subsequent conversion to text. Subsequently, the information is provided with the further header according to an exemplary embodiment of the invention, which further header is, among other things, necessary to trigger further steps on board the aircraft. Combining the actual information with the further header takes place, for example, in a data processing unit, e.g. by a program on a computer, where preferably conversion to the message in a mobile communications standard also takes place. Transmission of this message again takes place in the known manner just like transmission of a pure message, which has, for example, been input on a mobile telephone.

For transmitting the message body is provided with a message header contacting necessary data according to the mobile communication standard.

In an exemplary embodiment text information is generated, and the prepared text information is converted to an SMS message in the short message service (SMS) mobile communications standard, and interpretation of the message takes place by a text interpreter. In this method as small a data quantity as possible is generated, which has to be sent to the aircraft. The SMS standard is, furthermore, characterised in that it is widely used, which in turn favours global use of the invention.

Instead of generating pure text information, in a further exemplary embodiment of the method according to the invention image information can also be generated, and the prepared image information can be converted to an MMS message in the multimedia messaging service (MMS) mobile communications standard. In this way additional information can be transmitted and made available in the aircraft. The transmission of image information corresponds to the generally increasing information transmission by images instead of information transmission by text.

In an exemplary embodiment of the method an image is shown with the information, for example text information, overlaid, wherein the image is stored in a database on board the aircraft. In this way presentation of the information that is attractive to the passengers or the crew and that at the same time is informative can be achieved, which information can also easily be integrated in the individual appearance of the aircraft in that the underlying images can conform, for example, to the corporate identity as well as to any other type of content. Instead of using one image, it is also possible to use several images or moving images, i.e. videos as underlying images.

In a further exemplary embodiment of the method encoding of the information takes place prior to conversion to a message, for example to an SMS message or to an MMS message, and decoding takes place during interpretation of the message in order to ensure as secure a data exchange as possible.

A further exemplary embodiment provides for the message, during the interpretation, to be checked for causality and information type with the use of a database on board the aircraft, in order to make differentiated further processing of the information possible.

In a still further exemplary embodiment during the interpretation the type of information or priority of information is identified, and from several display devices at least one of the display devices is selected, and the text information is transmitted to the at least one selected display device. In this way information can be assigned in a targeted manner so that one and the same data communication can at the same time be used for different areas of application; for example information for the cockpit can also be transmitted as SMS or MMS with a further header. By the identification, presentation then takes place exclusively on displays in the cockpit or in the crew area.

In order to create the option of calling off the information anew or at a later point in time, an exemplary embodiment of the method provides for the information to be stored on an internal storage device, and for the information stored on the storage device to be called off, when required, by way of an interface. The interface can also serve to use the information for graphic further-processing. Consequently, in the case of a text message it is, for example, possible to present the text not only as pure text but also to present it, by data processing with the use of corresponding software, in some other form, for example in animated form.

In a further exemplary embodiment, a method for transmitting information to an aircraft is provided with the steps of: generating information; preparing the information for a message body of a message in a mobile communication standard, which message comprises the message body and a message header, by providing the information with a further header, said further header comprising display specifications; converting the prepared information into a message in a mobile communication standard, wherein the message comprises a message header and a message body comprising the information prepared with the further header; transmitting the message to an information system with a display control unit on board the aircraft; interpreting the message by analysing the further header of the message body and separating the information and the display specifications by the aircraft-internal information system; controlling the display by the control unit according to the display specifications in the further header; and presenting the information on an on-board display of the aircraft.

The further header contains information required for further handling of the data to be displayed. For example, the further header can contain certain display categories or display priorities. Thus, the extracted display specifications are forwarded to the control unit to control the display device according to the instructions in the specifications and to display the generated information.

### BRIEF DESCRIPTION OF THE DRAWINGS

Below, for further explanation and to provide a better understanding, the invention is explained in more detail by exemplary embodiments with reference to the enclosed drawings. The following are shown:

FIG. 1 an overview of data communication;

FIG. 2 a diagrammatic view of the significant components;

FIG. 3 a diagrammatic view of the process steps of an exemplary embodiment; and

FIG. 4 an example of a layered view of an image comprising information.

### DETAILED DESCRIPTION

It should be noted that the term “comprising” does not exclude other elements or steps and “a” or “an” does not exclude plurality. Also elements described in association with different embodiments may be combined.

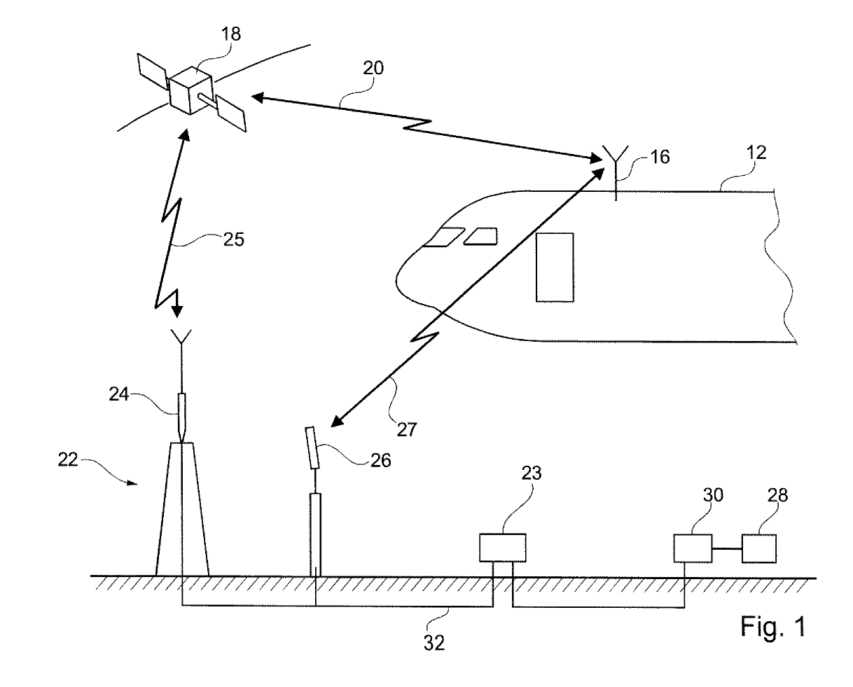

FIG. 1 shows an aircraft 12, for example an aeroplane. In the context of the present patent application the term “aircraft” also refers to airships or helicopters. The aircraft 12 comprises an information system 14, which will be discussed in more detail later in the context of the other figures. FIG. 1 only shows an antenna 16 of the information system 14, by which antenna 16 data from one or several transmitter devices can be received, preferably in the form of electromagnetic signals. The transmitter devices, can, for example, be a satellite system of which FIG. 1 shows a satellite 18 that is connected to the antenna by way of a communication link 20. The communication link 20 with one or several satellites presents itself as a possible solution in particular in the case of high flight altitudes and in regions without terrestrial signals.

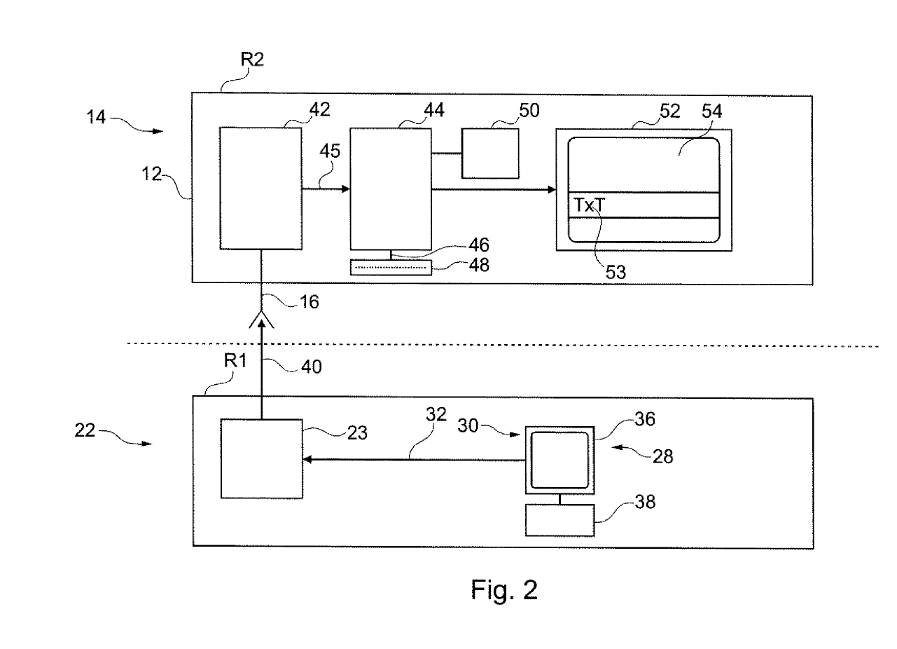

Furthermore, a ground system 22 is provided, which comprises a terrestrial transmitter 23 (see also FIG. 2). This is, for example, a transmitter device 24 that is connected to the satellite system, i.e. in FIG. 1 to the satellite 18, by way of a communication link 25. Of course, it is also possible for several transmitter devices 24 to be provided. Apart from this, the ground system 22 can also comprise other transmitter devices 26 which provide a further direct communication link 27 to the antenna 16, which presents itself as a possible solution in certain situations, for example in the parked position at the gate or while on the taxistrip.

The ground system 22 further comprises an input device 28 for inputting information, and a data processing unit 30 that provides the input with a further header and makes it available as a message body of a message. The message body is provided with a message header, together representing a message in a mobile communication standard. In the example shown the input is a text input that is provided with a further header and is subsequently made available as a text message in the short message service (SMS) mobile communications standard. In other words, the message body is added by a message header containing data such as sending and receiving address. If the message generated is an image, it is also provided with a further header, however, it is, for example, made available as an MMS message. Other standards for message formats in the area of mobile communications can, of course, also be used. In any case the message comprises the further header that makes possible further use on board of an aircraft.

The data processing unit 30 is connected to the terrestrial transmitter 23, i.e. in FIG. 1 to the transmitter devices 24 and 26, by way of the communication link 32.

Further, FIG. 2 shows a diagrammatic view of the essential components that are provided in order to make information available within the aircraft 12 in a simple and economical manner. The drawing shows the ground system 22 in the lower half, wherein for improved understanding a frame R1 is provided, which is merely intended to signify a functional affiliation and should therefore not be interpreted as being an assignment of location. The upper half shows the functional elements of the information system 14 in a frame R2, which also shows the functional affiliation, but at the same time also signifies that these components are located on board the aircraft 12.

Between the ground system 22 and the information system 14 a communication link is provided, in respect of which as examples the communication link 24 and the communication link 26 have already been mentioned, wherein for the sake of simplicity the communication link between the systems 14, 22 in FIG. 2 are designated by the arrow 40.

The data transmitted between the ground system 22 and the information system 14 preferably relates to SMS text messages in the short message service (SMS) mobile communications standard or to MMS messages. These SMS messages or MMS messages comprise text information or image information prepared with a further header. The further header comprises, for example, an identification code that contains security-related details and/or details relating to the type of information associated with the text information.

The ground system 22 comprises the input device 28, in the diagram shown as a computer 36 with a keyboard 38. The computer 36 at the same time also assumes the function of the data processing unit 30. In order to transmit data, the data processing unit 30 is connected to the transmitter 23 by the communication link 32 of the terrestrial data network. Connecting the data processing unit 30 to the connection 32 can, for example, take place by a modem and a telephone line. For simple and economical data transmission it is intended that the services of a telecommunications provider be used, which provider not only offers the services of data transmission but also the necessary infrastructure, part of which is, for example, the transmitter 23 and the connection 32.

On board the aircraft 12, data is received by the antenna 16 that is connected to a receiver 42 for receiving a message, in the exemplary embodiment shown for receiving an SMS message in the short message service (SMS) mobile communications standard. In the exemplary embodiment, this receiver 42 on board the aircraft 12 comprises a GSM module that exclusively comprises an SMS receive function. Furthermore, the receiver 42 is communicatively connected to an interpreter 44 by way of a data link 45. This data link can be implemented by wire or wirelessly, i.e. in the form of an on-board mobile communications network. The interpreter 44 is a text interpreter 44 that comprises an identification unit (not shown) whose function and operation is explained in more detail below in the context of the method according to the invention. If the MMS standard is applied, it is an image interpreter. Furthermore, an interface 46 with an input unit 48 is provided on the text interpreter 44. Moreover, the text interpreter 44 with a database 50 is connected to an internal memory on board the aircraft 12. The text interpreter 44 finally is connected to a display device 52 so as to be able to communicate in order to display the text information provided. The display device 52 is, for example, a display as used on board, e.g. such as those installed in the rear of the backrests on passenger seats, displays in the crew areas, or displays in the cockpit. Moreover, it can also be a central display in the cabin. The information transmitted from the ground system 22 to the information system 14 of the aircraft 12 is shown on the display device 52 for example as text 53 and is, for example, also combined with other content 54.

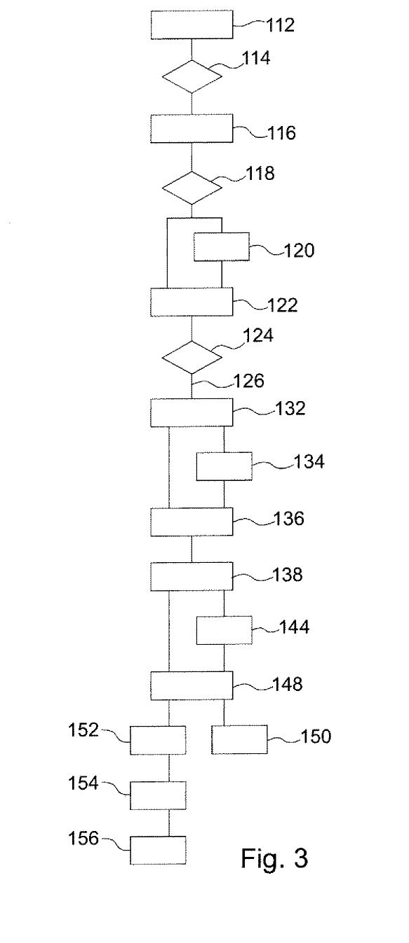

In FIG. 3, with reference to an exemplary embodiment using the SMS standard, the individual process steps are shown that are provided in order to make information, preferably text-based information, available on board the aircraft 12.

First, in a first input process 112, by the input device 30 information 114 is generated, i.e. text information, for example by inputting text via the keyboard 36. This can relate to news, sport results, the stock quotations or flight information, e.g. current information relating to the arrival airport or relating to changes in the connecting flights. The text information 114 can basically be generated at any location. Subsequently the text information 114 in a first preparation step 116 is given a further header so that the text information 114 is now present in the form of prepared text information 118. The further header comprises additional information that is necessary for further steps on board the aircraft 12, which steps will be explained in more detail later (see below). Depending on requirements, additional encoding 120 of the prepared text information 118 can take place. Of course, the text information 114 can also be encoded before the preparation step 116 takes place. Subsequently the prepared text information 118 is converted in a conversion step 122 to a message body of a message 124, i.e. to an SMS text message 124 in the short message service (SMS) mobile communications standard, said message 124 comprising a message header and the message body.

Subsequently the SMS text message 124 is transmitted to the terrestrial data transmission network of a telecommunication services provider 126, for example by a modem and a telephone connection. The SMS text message 124 is subsequently forwarded in a known manner, within the data transmission network, to a particular telephone number, i.e. to the telephone number of the receiver 42 of the aircraft 12, i.e. to the telephone number of the receiver 42 in the cabin of the aircraft 12. Depending on the position of the aircraft 12 this can also take place by way of a terrestrial radio network. However, as a rule the aircraft 12 will be flying at such a high altitude that forwarding the SMS text message 124 to the information system 14 on board the aircraft 12 takes place by way of the satellite 18 of the satellite system. The SMS text message 124 is received by the antenna 16 of the receiver and is forwarded to the text interpreter 44.

Thereafter, by the text interpreter 44 an analysis 132 of the further header of the SMS text message 124 takes place, as well as decoding 134 if applicable. Subsequently, separation 136 of the text information 114 takes place, followed by interpretation 138. In the analysis 132 of the further header in the context of the text information 114 said further header is checked, by the database 50 on board the aircraft 12, in relation to the causality and information type of the text information 114. In this arrangement assignment of various information types to various presentation scenarios that are deposited on board can also take place, i.e. depending on the information type, various presentations are provided. As soon as the text interpreter 44 has identified the type of information, in the case of several display devices 52 at least one of the display devices 52 is selected 144, and the text information 114 is transmitted to the at least one selected display device 52.

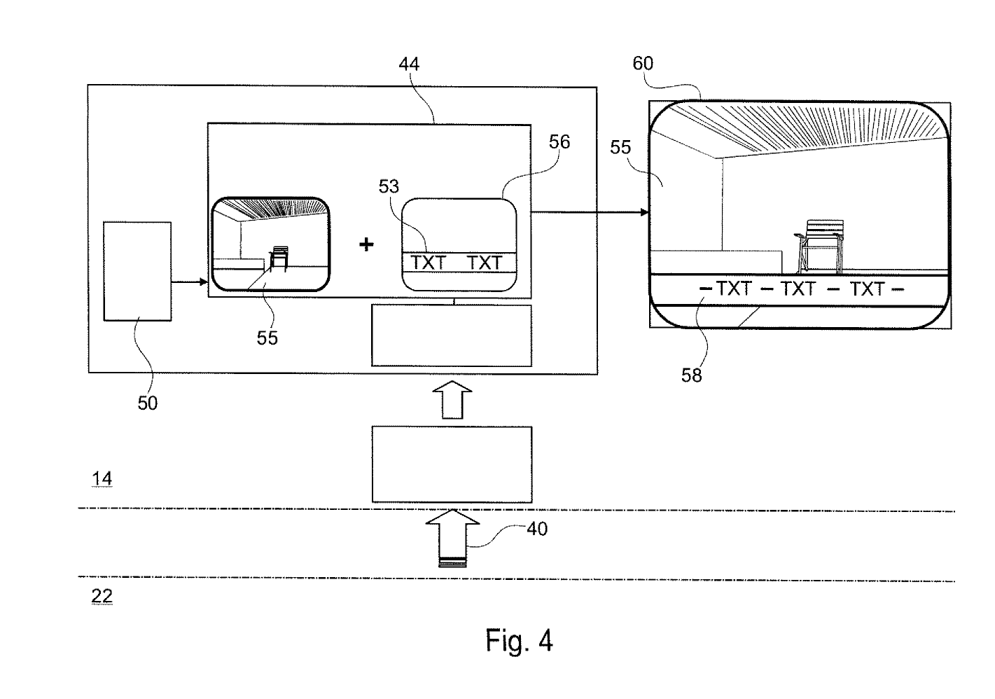

Before the text information 114 is presented on board the aircraft 12 it is superimposed 148 on an image 54 so that subsequently the image 54 can be presented 150 with the text information 114 overlaid on it, as shown in more detail in FIG. 4. As soon as the text information 114 is available, an image 55 or video to go with it is selected from the on-board database 50 and is transferred to the text interpreter 44. Subsequently the text information 114 is graphically converted to a similar format 56 so that the two presentations 55, 56 then only have to be presented in layers. For example, messages in the form of a liveticker 58 can be backed by a corresponding image 55, depending on the topic. Consequently, despite the small quantity of data that is sent from the ground system 22 to the aircraft 12, current information can be made available within the aircraft 12 also in flight, which data furthermore distinguishes itself by improved, more informative or graphically more attractive presentation 60.

To supplement an immediate presentation 150 in layers, the text information 114 can also be pre-stored 152 in an internal memory, i.e. for example also in connection with the database 50, and can be called off 154 when required at a later point in time and can then be presented 156.

1. An information system for an aircraft, comprising:
a receiver for receiving a message in a mobile communication standard from a ground system, wherein the message contains a message header and a message body comprising information prepared with a further header;
an interpreter that analyses the further header of the message body in the message and separates the information; and
at least one display device for presenting the information,
wherein the receiver is connected to the display device by way of the interpreter so as to be able to communicate.

2. The information system of claim 1, wherein the information comprises a text information, the message comprises an SMS message in the SMS (short message service) mobile communications standard, and the interpreter comprises a text interpreter.

3. The information system of claim 1, wherein the information comprises image information, and the message comprises an MMS message in the MMS (multimedia messaging service) mobile communications standard.

4. The information system of claim 1, wherein the further header comprises an identification code which comprises at least one of security-related details and details relating to the type of information.

5. The information system of claim 4, wherein the interpreter comprises an identification unit in which details relating to the verification of the security-related details of the further header, and an assignment of various types of information to at least one of various presentations and to at least one of various display devices, are deposited.

6. The information system of claim 1, wherein the information provided is presented on the display device combined with other content.

7. The information system of claim 1, wherein the receiver on board the aircraft comprises a GSM module that only comprises a receive function.

8. The information system of claim 1, wherein the interpreter comprises an interface with an input unit and is connected to a database and an internal memory on board the aircraft.

9. An aircraft comprising an information system, the information system comprising:
a receiver for receiving a message in a mobile communication standard from a ground system, wherein the message contains a message header and a message body comprising information prepared with a further header;
an interpreter that analyses the further header of the message body in the message and separates the information; and
at least one display device for presenting the information,
wherein the receiver is connected to the display device by way of the interpreter so as to be able to communicate.

10. A system for transmitting text-based information to an aircraft with an information system for an aircraft and a ground system for data processing, the system comprising an information system and a ground system,
the information system comprising:
a receiver for receiving a message in a mobile communication standard from a ground system, wherein the message contains a message header and a message body comprising information prepared with a further header;
an interpreter that analyses the further header of the message body in the message and separates the information; and
at least one display device for presenting the information,
wherein the receiver is connected to the display device by way of the interpreter so as to be able to communicate; and
the ground system comprising
an input device for inputting the information, and
a data processing unit that adds the further header to the input and makes said prepared information available as the message body of the message in the mobile communication standard, as well as comprising a transmitter that transmits the prepared message.

11. A method for transmitting information to an aircraft, comprising:
generating information;
preparing the information for a message body of a message in a mobile communication standard, which message comprises the message body and a message header, by providing the information with a further header;
converting the prepared information into a message in a mobile communication standard, wherein the message comprises a message header and a message body comprising the information prepared with the further header;
transmitting the message to an information system on board the aircraft;
interpreting the message by analysing the further header of the message body and separating the information by the aircraft-internal information system; and
presenting the information on board the aircraft.

12. The method of claim 11, wherein text information is generated, and the prepared text information is converted to an SMS message in the short message service (SMS) mobile communications standard, and interpretation of the message takes place by a text interpreter.

13. The method of claim 11, wherein image information is generated, and the prepared image information is converted to an MMS message in the multimedia messaging service (MMS) mobile communications standard.

14. The method of claim 11, wherein an image is shown with the information overlaid, wherein the image is stored in a database on board the aircraft.

15. The method of claim 11, wherein encoding of the information takes place prior to conversion to the message, and decoding takes place during interpretation of the message.

16. The method of claim 11, wherein the message, during the interpretation, is checked for causality and information type with the use of a database on board the aircraft.

17. The method of claim 16, wherein during the interpretation the type of information is identified, and from several display devices at least one of the display devices is selected, and the information is transmitted to the at least one selected display device.

18. The method of claim 11, wherein the information is stored on an internal storage device, and the information stored on the storage device is called off, when required, by way of an interface.

19. An information system for an aircraft, comprising:
a receiver for receiving a message in a mobile communication standard from a ground system, wherein the message contains a message header and a message body comprising information prepared with a further header, said further header comprising display specifications;
an interpreter that analyses the further header of the message body in the message and separates the information and the display specifications;
a display control unit on board the aircraft; and
at least one on-board display device for presenting the information on board of the aircraft,
wherein the receiver is connected to the display device by way of the interpreter so as to be able to communicate;
and wherein the display control unit controls the display device in accordance to the display specifications.

20. A method for transmitting information to an aircraft, comprising:
generating information;
preparing the information for a message body of a message in a mobile communication standard, which message comprises the message body and a message header, by providing the information with a further header, said further header comprising display specifications;
converting the prepared information into a message in a mobile communication standard, wherein the message comprises a message header and a message body comprising the information prepared with the further header;
transmitting the message to an information system with a display control unit on board the aircraft;
interpreting the message by analysing the further header of the message body and separating the information and the display specifications by the aircraft-internal information system;
controlling the display by the control unit according to the display specifications in the further header; and
presenting the information on an on-board display of the aircraft.
